(19) United States
(12) Patent Application Publication
(10) Pub. No.: US 2002/0066344 A1
(43) Pub. Date: Jun. 6, 2002

(54) Film hole punching system, method and article of manufacture

(76) Inventors: Harold A. Ewing, Pryor, OK (US); Bradley D. Gottlob, Locust Grove, OK (US)

Correspondence Address: Mark G. Kachigian, HEAD, JOHNSON & KACHIGIAN, 228 West 17th Place, Tulsa, OK, 74119, US

(21) Appl. No.: 09/730,131

(22) Filed: Dec. 5, 2000

Related U.S. Application Data
(60) Provisional application No. 60/171,055, filed on Dec. 16, 1999.

(51) Int. Cl. B26D 5/00; B26D 3/00

(52) U.S. Cl. 83/34; 83/52; 83/76.9; 83/694

(57) ABSTRACT

An optical encoder is mounted on the end of the shaft of one roller, which is in turn mounted on framework of the equipment and is driven by a film of material. A computer receives a number of impulses per roller revolution with such impulses transmitted from the optical encoder during the film's passing over the roller. Software of the computer is programed with the exact circumference of the roller before shipment and the computer calculates the amount of film that has passed over the roller and fires solenoid valves to precipitate punching operations based upon the distance traveled by the film. Upon receiving an electrical impulse from the computer control, a solenoid valve releases an intermittent burst of compressed air through a tube to a housing which contains a plastic actuator, a plunger and a spring and which has several holes drilled in it to facilitate movement of said compressed air. The burst of compressed air forces the actuator and plunger downward. After the actuator bottoms out said burst of air is exhausted, the plunger continues to travel downward until the tip of the plunger, containing a steel ball contacts a circular hole in the die which is located in the lower portion of the machine. The force of the ball striking the die cuts the material that is moving between the two components. A spring which rests between the housing and the plunger returns the plunger and actuator to their resting position. The cut out pieces of material travel downward through the hollow center of the die and its holder and are carried by the stream of air created by the suction of the vacuum system through the chambers and ducts of the machine being deposited in a receptacle, preventing the haphazard accumulation of scrap occurring with the prior art.

### REFERENCE TO PENDING APPLICATIONS

This application is related to Provisional Patent Application No. 60/171,055, filed on Dec. 16, 1999 and entitled Film Hole Punching System, Method and Article of Manufacture.

### REFERENCE TO MICROFICHE APPENDIX

This application is not referenced in any microfiche appendix.

### TECHNICAL FIELD OF THE INVENTION

In general, the present invention relates to automated hole punching systems. In particular, the present invention is directed to an automated film punching system, method and article of manufacture to accommodate pre-programmed, single or diverse pattern film hole punching requirements irrespective of film transport speed and spacing between subsequent punching operations.

### BACKGROUND OF THE INVENTION

The following patents are representative of film hole punching and film hole punching related prior art.

U.S. Pat. No. 2,799,340 issued to Otto Mueller on Jul. 16, 1957 discloses a hole punching device and method.

U.S. Pat. No. 3,096,015 issued to Wilburn F. Bradbury on Jul. 2, 1963 discloses a ball perforator which relates to a high speed perforator using ball type punches and adapted to punch on tape or other record media, coded or encoded data, from high speed systems such as calculators, business machines, computers and telegraphic systems.

U.S. Pat. No. 4,123,956 issued on Nov. 7, 1978 to David L. Harvey discloses a self-centering device for blanking out or punching holes through relatively thin gauge materials and particularly elastomeric materials such as rubber or plastic.

U.S. Pat. No. 4,596,359 issued on Jun. 24, 1986 to Per-Ole Mordli discloses a punching device for punching code key cards and the like comprising a plurality of punches, each of which is selectively moveable in respective guide. Balls of ferromagnetic material are positional in a first punching position and a second passive position. Solenoids with moveable cores are arranged to selectively move the balls between the first and second positions.

U.S. Pat. No. 4,674,372 issued on Jun. 23, 1987 to George A. Mobley discloses a pneumatically actuated hole punch which employs a ball and die punching arrangement in which the ball is free floating and the punching impact is between the ball and the plunger rather than between the ball and the die. The plunger incorporates a concave surface to correctly position the ball relative to the die upon cutting of the desired opening.

U.S. Pat. No. 5,226,735 issued on Jul. 13, 1993 to Daniel Beliveau discloses a perforated plastic bag for packaging fruits or vegetables. The bag is made of opaque, flexible plastic sheet material. The rear wall of the bag is however provided with a transversal window made of transparent, flexible plastic sheet material, extending over the width of the bag and comprising a plurality of perforations distributed over its surface. The transparent plastic sheet material is thicker than the opaque plastic sheet material; it requires additional mechanical resistance due to the perforations. A method and apparatus fabricate the plastic bag from two strips of opaque plastic sheet material, and a strip of transparent plastic sheet material. In accordance with this method, the three strips are placed side by side with the transparent strip in the center; the adjacent borders of the strips are heat welded together to convert the three strips to a single band; this band is folded to form a two-layer band; and this two-layer band is transversely cut at longitudinally spaced apart locations thereof with the two layers heat welded on both side of each cut.

U.S. Pat. No. 5,907,985 issued on Jun. 1, 1999 to Raschid Jose Bezama et al discloses a punch tool for punching a slug from a workpiece. The punch of the punch tool has a reciprocating travel path with a transition region where the punch changes direction. A die plate of the punch tool has an aperture. A support bushing disposed in the aperture of the die plate provides support for the workpiece and has an underside and an opening through which the punch card the slug pass. A nozzle disposed in the aperture of the die plate provides an internal passage for the removal of punch slugs from the tool. The nozzle has a top and a side wall with a hole disposed in the side wall adjacent the transition region of the reciprocating travel path of the punch. The nozzle, the supporting bushing, and the die plate are integrated to form a flow path delivering a gas flow to the hole in the nozzle. The flow path and the hole direct the gas flow on a slug attached to the punch in the transition region of the reciprocating travel path of the punch to remove the slug from the punch.

U.S. Pat. No. 5,960,533 issued on Oct. 5, 1999 discloses an apparatus for manufacture of laminated parts wherein elongated thin strip stock is blanked to form interlocking laminas for electric motor or generator rotors or stators at successive blanking stations. At a final assembly station the laminas are stacked and pressed into interlocking relationship. In response to an operator input a predetermined number of reversals, or half turns about the stack axis of the previously stacked lamina are provided in order to compensate for nonuniform strip thickness to obtain a rotor or stator of substantially uniform height. Alternatively the thickness of the strip stock is gauged at transversely spaced points on the strip to determine cross feed thickness variation in the strip whereupon the stacked laminas are automatically provided with a number of reversals about the stack axis in response to a thickness differential that would result in a parallelism error in the stack that exceeds a predetermined amount. Rotor conductor slots are formed in the stack laminas and are skewed to the stack axis by providing arcuate indexing of each lamina relative to the next preceding lamina in the stack by an arcuate increment that is automatically determined in response to operator entered inputs relative to the stack height, the skew angle, nominal lamina thickness and skew direction.

U.S. Pat. No. 3,299,761 issued to Rubin Goldman on Jan. 24, 1967 purports to disclose a punching apparatus and alleges a new and improved multi-punch assembly for perforating thin sheet stock. The device may include as a part thereof a knife for simultaneously slitting the stock as it is perforated.

U.S. Pat. No. 3,463,042 issued to Rubin Goldman on Aug. 26, 1969 purports to disclose a pneumatic punch which comprises a die, punch and cylinder holder frame. The die is mounted in the die holder. A sleeve is mounted in the punch holder and is aligned with the die, and a cylinder assembly including a plunger is mounted in the cylinder holder. A ball is mounted in the lower end of and slidably axially in the sleeve, and a stem is locked in the sleeve above the punch and is movable axially in the sleeve toward and away from the ball. Pneumatic actuating means, including an impulse valve is connected to the cylinder assembly for driving the plunger of the cylinder against the stem causing the stem to drive the ball against the die. A relatively heavy spring is secured to the stem for returning the stem to its position away from the ball, and the spring also assists in returning the plunger to its withdrawn position in the cylinder.

With respect to Goldman U.S. Pat. 3,299,761 and 3,463,042 hereinafter collectively referred to as “Goldman” the following distinctions between said patents and the present invention are provided as follows:

1. The Goldman machine utilizes a complex multiple component plunger and air cylinder to fire plungers. An air cylinder fires a rod which strikes a spring mounted plunger which strikes a die and effectuates the punching of a hole. The die is held in another complex unit which is threaded onto the lower unit of the Goldman machine. The cylinder is then fired by a pulse of air from a solenoid valve. The solenoid is fired by a timer without regard as to how much plastic or other film has traversed the machine between punching operations. Consequently, hole spacing as provided for in the Goldman machine is merely a trial and error method of adjustment of dwell time on the solenoids. Specifically, the speed at which the Goldman machine punches holes lacks any correlation to, and fails to address, dynamic adaptation to variations in the speed of a plastic film traversing the punching apparatus.

The distinguishing characteristics of the present invention from the benefits purportedly disclosed and claimed in the above noted Goldman patents are as follows:

1. The present invention provides for a one-piece air cylinder and plunger unit which offers greatly increased efficiency and economy over the Goldman devices;

2. A die unit which the operator of the present invention can insert in a drill hole in the lower unit of the machine by hand;

3. Use of an optical encoder to transmit pulses to a computer which in turn calculates line (a.k.a. “line” or “web”) speed and fires solenoids in the proper sequence to create a pre-programmed hole punching design and sequence. The Goldman machine requires that the film line be brought up to speed, the punch unit turned on and then adjusted manually until hole spacing between punching operations is correct. Consequently, all film processed by the Goldman machine during this period of “start up time” will be scrap material. The present invention immediately processes film within the transport line as soon as it is turned on. As the computer calculates the amount of film passing through the machine and places holes properly irrespective of the speed of the line. The present invention also accommodates the punching of varying patterns of holes. For example, in the invention's preferred embodiment, the invention can punch one hole, wait for the traversing of three inches of film, punch 32 holes, wait for the traversing of 12 inches of said film, then punch 20 holes, etc. until a desired punch pattern has been accommodated. Contrary to Goldman, the present invention provides, discloses and claims that subsequent and varying punching operations are properly sequenced and spaced irrespective of the film speed as it is transported through the machine. Further, the Goldman machine as disclosed fires all solenoids, or none, without variation capability, while the present invention also stores a plurality of patterns in memory to be recalled as needed for punching operations. Goldman is absent any discussion of such capability. The present invention provides for a vacuum system which removes cut-out or punched pieces to a storage container. Goldman, again, is absent any discussion of such provision. The present invention also can dynamically adjust the power with which each individual plunger fires allowing for minimized die wear and operation of the machine for longer periods without the requirement for changing dies.

U.S. Pat. No. 4,495,582 issued on Jan. 22, 1985 to Robert A. Dessert, et al, and subsequently assigned to Harris Graphics Corporation, discloses a control system for pre-setting and operation of a printing press and collator. This process and apparatus for manufacturing a multi-part form uses film presses having printing stations and processing stations at which operations are performed on films in registry with a series of printed images, and uses a collator to assemble related films from said presses, and to perform additional operations on assembled films in registry with images thereon. A digital job description of a form is created, including a location of printed images on several parts of the form and location of process items, e.g. perforations, holes, or cuts on parts of the form. The job description is stored in the memory of a computer with a job identifying code. Also, a digital description is created of images to be printed on the form, and stored in memory with the job identifying number. The image descriptions are recalled from memory and used to create printing plates for the presses and to pre-set printing and processing sections of a press for each part of the form. The parts of the form are then produced on the presses and supplied to the collator. The job description is recalled from memory and used to pre-set stations of the collator to assemble and complete processing of the multi-part forms. The computer also gathers and stores management data as the presses and collator operate, keeps a record of supplies/tools needed for each job and makes this information available to operators through terminals, and maintains records of jobs entered, work in process, and jobs shipped.

The present invention is patentably distinct from those features purportedly disclosed and claimed in U.S. Pat. No. 4,495,582 (hereinafter Dessert) in the following areas:

Dessert is intended and designed to operate web presses for printing paper, the only similarities that exits between Dessert and the present invention is the utilization of an optical encoder. However, Dessert utilizes the encoder only to clock the position of the film (a.k.a. “web”) and then uses programmable logic controls (a.k.a. “PLC's”) to locate placement of printing on the web. Dessert uses a computer only as a storage system for programs for the PLC's. The computer as represented in Dessert does not function as an integrated component part of the spacing, patterning and operation of the invention.

The present invention was designed for, but not limited to, the blown plastic film industry. The speeds of the plastic film and the blown film industry can be as fast as 1000 feet per minute. Punched holes may be required to be punched as closely as 2 inches apart along the web traversing punching apparatus. With respect to the blown film industry, thorough experimentation has revealed that programmable logic controls are incapable of operating quickly enough to fire plungers to effectuate the punching of holes through said film at an acceptable speed. Consequently, the present invention with respect to its operation and utilization of encoders can be summarized as follows:

(a) the optical encoder as utilized in the present invention sends pulses to the computer of the present invention. The computer of the present invention then counts the number of pulses received and multiplies the number of revolutions by the circumference of the rollers and particularly the roller attached to the encoder and then calculates the length of film which has traveled through the machine;

(b) the computer then calculates and fires solenoid valves at the programmed distances and locations, irrespective of web travel speed;

(c) the computer then performs calculations quickly enough to punch holes at a far more rapid rate than can be accommodated by the PLC's of the Dessert machine;

(d) the computer of the present invention also provides for calculations which allow one solenoid to fire with more force than others or at different times to create various patterns of holes in the plastic film.

In summary, the advantageous of the present invention over those purportedly disclosed and claimed by Dessert are higher web processing speed contributed to the present invention's utilization of a computer instead of PLC's, the ability to control individual solenoids and create varying punched patterns, the ability to store programs within the computer's memory of the present invention to be recalled as needed and, the ability to dynamically modify power setting as dies dull and stop cutting well.

### BRIEF SUMMARY OF THE INVENTION

This invention relates to punching a plurality of holes in a thin film, most usually plastic, by means of using a computer and an optical encoder to fire solenoid valves at intervals and sequences which have been programmed into the computer.

Manufacturers of plastic films are required to place holes in their product for various reasons. Some products to be packaged in the plastic bags or sheet being produced require holes for ventilation, for evacuation of excess air, for use in hanging bags on racks, etc. The most efficient method of creating these perforations is to mount a multiple punch unit on a portion of the bag making equipment. Holes will be punched at locations indicated by the computer and optical encoder while the equipment is cutting, forming and sealing the film to make plastic bags.

An optical encoder is mounted on the end of the shaft of one roller, which is in turn mounted on the framework of the equipment and is driven by the film of material. The computer receives a pre-determined number of impulses per revolution transmitted from the optical encoder while the film is passing over a roller as it travels through the machine frame. These impulses indicate to the computer the number of revolutions taken by the roller. Software of the computer is programed with the exact circumference of the roller before shipment. The computer calculates the amount of film that has passed through the machine, and fires solenoid valves as it is instructed by the program being run at the current time. The frame of the machine in the invention's preferred embodiment, without limitation, may contain from one to 32 punch assemblies placed on 1 ½ spacing or multiples thereof. Each punch assembly is connected to a solenoid valve by means of a plastic tube mounted to the assembly housing cap by means of a hole in the cap. Each solenoid valve is under constant pressure of compressed air supplied from a manifold mounted on the machine frame. Upon receiving an electrical impulse from the computer control, the solenoid valve then releases an intermittent burst of compressed air through a tube to a housing which contains a plastic actuator, a plunger and a spring and which has several holes drilled in it for movement and exhaust if air. The burst of compressed air acts on the actuator, forcing it and the plunger to be driven down rapidly until the bottom end of the actuator strikes the bottom of a counter bore in the housing causing it to stop. After the actuator bottoms out and the burst of air is exhausted through the holes in the housing, the plunger continues to travel downward until the tip of the plunger containing the steel ball contacts the circular hole in the die which is located in the lower portion of the machine. The force of the ball striking the die cuts the material that is moving between the two components. The ability of the steel ball to roll in its plunger socket allows a clean cut to be made while the film of plastic film is in motion. The spring which rests between the housing and the plunger returns the plunger and actuator to their resting position.

The cut out pieces of web material will travel downward through the hollow center of the die and its holder and will be carried by the stream of air created by the suction of the vacuum system through the chambers and ducts of the machine and will be deposited in a receptacle. This prevents the accumulation of cut out pieces on the machine and the floor surrounding the machine which occurs with the prior art.

Consequently, in view of the limitations of the prior art and advantages offered by the present invention, is a primary object of the present invention to provide a multiple punch unit, which is controlled by a computer, and can be easily programmed to place holes at various locations and in various patterns on plastic bags as they are being produced.

Another important object of the present invention is to provide a punch unit which can store in computer memory, the exact spacing of holes for several different jobs and can recall those programs when they are needed at a later date. Memory retention saves the time and expense of setting up each job each time it is run.

A further object of the present invention is to allow products to be produced at top quality as soon as the film starts moving. The optical encoder communicates with the computer to place holes at the proper distances no matter how fast or slow the speed of the film passing through the machine. Prior art is powered by timing devices, and must be manually regulated in order to obtain punch speeds which, combined with film speed result in proper spacing of holes. This results in scrap material being produced at great expense until the machine is regulated to line speed.

Yet another object of the present invention is to use a computer control system to adjust the length of time compressed air is applied to each of the solenoid valves independent of the others. This allows the operator to increase or decrease the force with which an individual plunger strikes an individual die. This allows the unit to keep operating and producing good material even though one or more dies may be becoming dull. Prior art requires that increased air pressure be applied to multiple dies in order to compensate for one dull die. This causes premature wear on the dies which are not dull or causes production to stop while the one dull die is replaced.

Another object of the present invention is to provide an arrangement of Master/Slave air regulators so that the pressure of the compressed air being supplied to each bank of eight valves may be adjusted independently of the other banks of valves. These changes in pressure may be obtained by adjusting the Master regulators located at the computer control which in turn causes the Slave regulators to changes pressure settings to match the Master regulators.

Another important object of this invention is to provide a means whereby the computer system reads a signal sent to it each time a bag making machine in the same production line closes to make a seam in a bag. The computer may be programmed to place holes specified distances from the bag seam as required.

An additional object of the present invention is to provide a computer control system which is software based and can be easily and inexpensively programmed by existing plant personnel to control the solenoid valves, plungers, dies, etc. To produce infinitely varying hole patterns on a film. This control allows film producers to provide their customers with hole patterns which are not possible with prior art and will, therefore, give the film producers advantages over their competition as far as unique products available to their customers.

Another important object of the present invention is to provide a means whereby a vacuum system may be used to transport cut out pieces of material through chambers and ducts and deposit them in a receptacle for recycling. Prior art has no such provision for capture and accumulation of cut out waste, resulting in waste accumulating on the factory floor, equipment, etc.

### DESCRIPTION OF THE DRAWINGS

FIG. 1 illustrates a front elevation of the machine showing one unit each of a plunger housing and a die assembly.

FIG. 2 illustrates an end view of the machine shown in FIG. 1 with the optical encoder, computer control module, air control system and bag machine shown diagrammatically.

FIG. 3 illustrates a cross-sectional view of one of multiple punch and die assemblies shown in FIG. 1.

FIG. 4 illustrates an overview logic flow diagram of software instructions according to the invention's preferred embodiment.

### DETAILED DESCRIPTION OF THE PREFERRED EMBODIMENT

While the making and using of various embodiments of the present invention are discussed in detail below, it should be appreciated that the present invention provides for inventive concepts capable of being embodied in a variety of specific contexts. The specific embodiments discussed herein are merely illustrative of specific manners in which to make and use the invention and are not to be interpreted as limiting the scope of the present invention.

The claims and the specification describe the invention presented and the terms that are employed in the claims draw their meaning from the use of such terms in the specification. The same terms employed in the prior art may be broader in meaning than specifically employed herein. Whenever there is a question between the broader definition of such terms used in the prior art and the more specific use of the terms herein, the more specific meaning is meant.

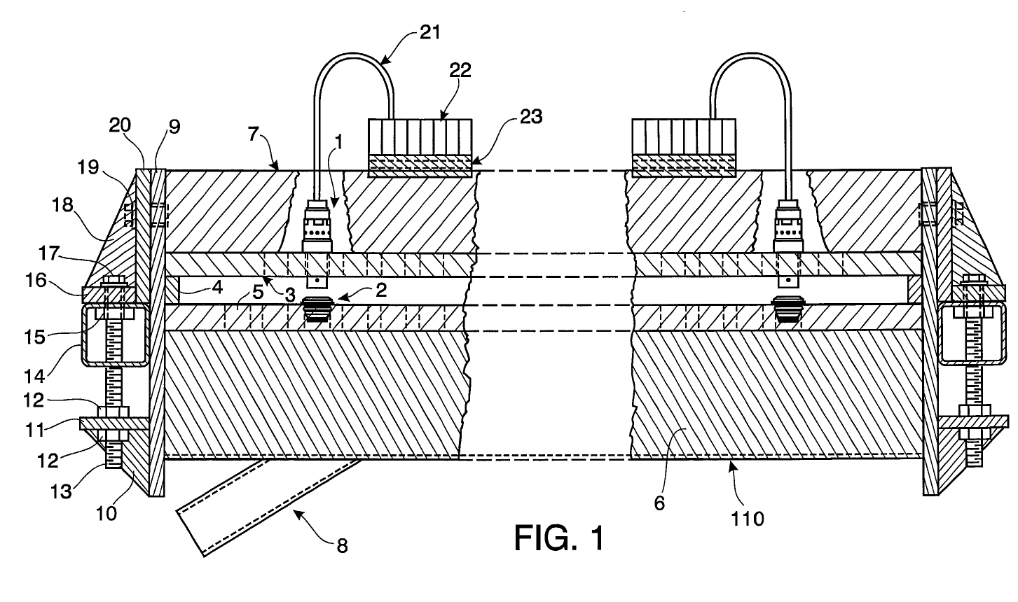

While the invention has been described with a certain degree of particularity, it is clear that many changes may be made in the details of construction and the arrangement of components without departing from the spirit and scope of this disclosure. It is understood that the invention is not limited to the embodiments set forth herein for purposes of exemplification, but is to be limited only by the scope of the attached claim or claims, including the full range of equivalency to which each element thereof is entitled. Turning now to FIG. 1.

To facilitate ease of understanding, FIG. 1 for purposes of enabling disclosure, illustrates two units of plunger and die assemblies mounted in the assembly, though the invention is intended to accommodate multiple such units. The assembly shown includes a pair of frame tubes 14 which comprise part of its frame and a pair of plates 15 welded inside said tubes 14. Tubes 14 are through bored to allow the passage of a jack bolt 13.

The end frames of the machine consist of two major units, upper and lower, which cooperate to allow upward and downward adjustment of a machine head 110 to accommodate proper passage of a film (a.k.a. “web”) material including, but not limited to polyethylene, metal, fibrous, or other web material to be punched. The upper unit consists of plate 16, through bored in two locations to allow the passage of bolts 17, and drilled and tapped at one location to accept the threads of jack bolt 13 which is welded at a junction to plate 16 to create a permanent attachment. Plate 18, and plate 20 embodies a milled slot to allow insertion and passage of bolt 19. Plates 16, 18 and 20 are welded together in such a fashion so as to comprise the upper unit of the end frame. The lower unit of the end frame consists of plate 9 which is drilled and tapped to accept bolt 19, and to which are welded plate 10 and plate 11, with said plates, 10 and 11 drilled to allow insertion and passage of bolt 13.

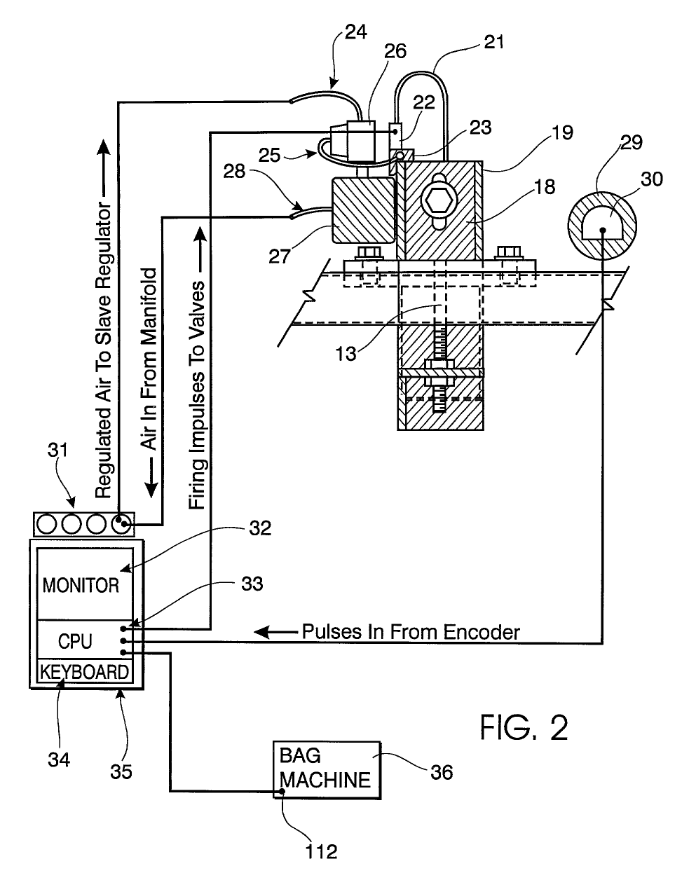

As shown in FIG. 1, upward or downward adjustment of the machine head is accomplished by loosening bolt 19 and hex nuts 12 on each side of plate 11, adjusting hex nut 12 on the lower side of plate 11 upward or downward as needed to bring the machine head to the required level, then tightening bolt 19, and hex nuts 12. Two frame members 3 and 5 extend between the plates 9, are separated by blocks 4 and welded to plates 9. Two upper frame members 7 extend between plates 9 and are welded to plates 9 and frame member 3. A “U” shaped vacuum chamber 6 extends between plates 9 and is welded to plates 9 and frame member 5. An outlet tube 8 is welded to vacuum chamber 6 to allow outflow of cut pieces of material to the vacuum system. An aluminum manifold 23 is attached to frame member 7 for each group of solenoid valves 22 on the machine as will be discussed and disclosed further in association with FIG. 2.

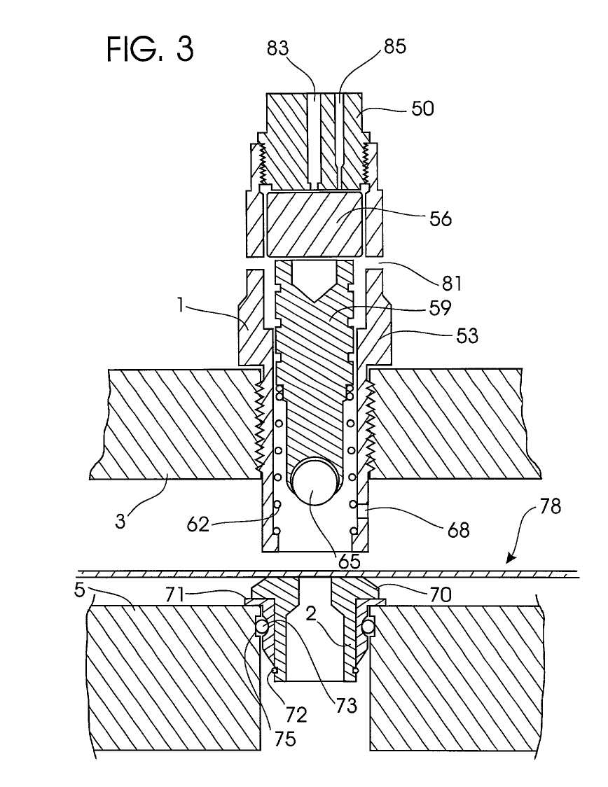

In FIG. 2 a manifold 23 allows a constant supply of regulated air from slave regulator 26 to be applied to solenoid valves 22 at all times by means of plastic tube 25. Each time said solenoid valve 22 receives an electrical impulse from the computer control module 35 it opens for the length of time programmed into the central processing unit (a.k.a. CPU) 33 and by means of a supply of regulated air through plastic tube 21 allows a plunger to strike the die as further detailed in association with FIG. 3.

FIG. 2 further illustrates a compressed air manifold 27 which is supplied with compressed air from the manufacturing facility's system. Air manifold 27 supplies air by means of tube 28 to the master air regulator 31 which regulates the pressure of the compressed air and transmits that pressure through tube 24 to slave regulator 26. Slave regulator 26 automatically adjusts its pressure regulation of the air being supplied to it from manifold 27 to match the setting of the master regulator 31. This compressed air is suppled to the manifolds 23 through tubes 25 so as to keep a constant supply of compressed air to the solenoid valves 22.

Continuing with FIG. 2. As film is produced by the manufacturing plant, it feeds over roller 29. Optical encoder 30 which is mounted on the shaft of roller 29 transmits a known number of pulses per revolution to the CPU 33. CPU 33 has been programmed with the exact circumference of roller 29. CPU 33 calculates the length of the film passing over roller 29, reads the program being run at the time and sends electrical impulses to solenoid valves 22 to cause them to fire at the proper time to place holes where needed in the film. Programs are entered, edited, stored in memory, etc. By use of the computer monitor 32 and keyboard 34 which are contained in the computer control module 35.

In some cases, the present invention will be used to punch holes in plastic bags rather than in a web of material. To produce such bags, a web of film is run through an additional machine which heat seals and perforates across the web to produce bags which can be torn from rolls. When bags are produced, holes are to be punched at specific distances and spacings away from the bottom seam in the bag. The present invention is programmed to wait for an electrical impulse from a contact switch on the bag machine 1 12 indicating that a seam has been made in the bag and holes are to be punched in the web material. The present invention will provide instructions to place punches at specific distances, for example two punches 6″ away from the seam, 6 punches 9″ away from the seam, and three punches 18″ away from the seam. The present invention may be programmed to place holes through a plurality of different locations via a plurality of instruction sequences. After the invention has executed one cycle and fired the proper hole punching plungers, it will stop and wait for another impulse from the bag machine 36 before punching another cycle of holes. Turning now to FIG. 3.

FIG. 3 illustrates a cross-section of the invention's preferred embodiment punch assembly 1, and die assembly 2, which cooperate to punch holes in a web material, while said material is passing between the two units. Each time a solenoid valve 22 receives an electrical impulse from CPU 33, it opens and allows compressed air to flow through tube 21 to a plunger assembly 1. Compressed air passing through hole 83 in housing cap 50 moves actuator 56 downward which pushes plunger 59 downward overcoming the resistance of spring 62. Movement of actuator 56 is halted when it strikes a step in housing 53. At this point, the compressed air is exhausted through holes 81 and 85 in housing body 53. Plunger 59 continues to move downward from momentum until the steel ball 65 strikes die unit 2 and rebounds to be held in its original starting position by the force exerted by spring 62. The air compressed by the return of plunger 59 and actuator 56 is exhausted through the vent hole 83 in housing cap 50. Hole 68 in housing 53 allows passage of air to prevent vacuum drag on plunger 59 as it is returned to its original position by spring 62, and the plunger assembly is ready for another cycle.

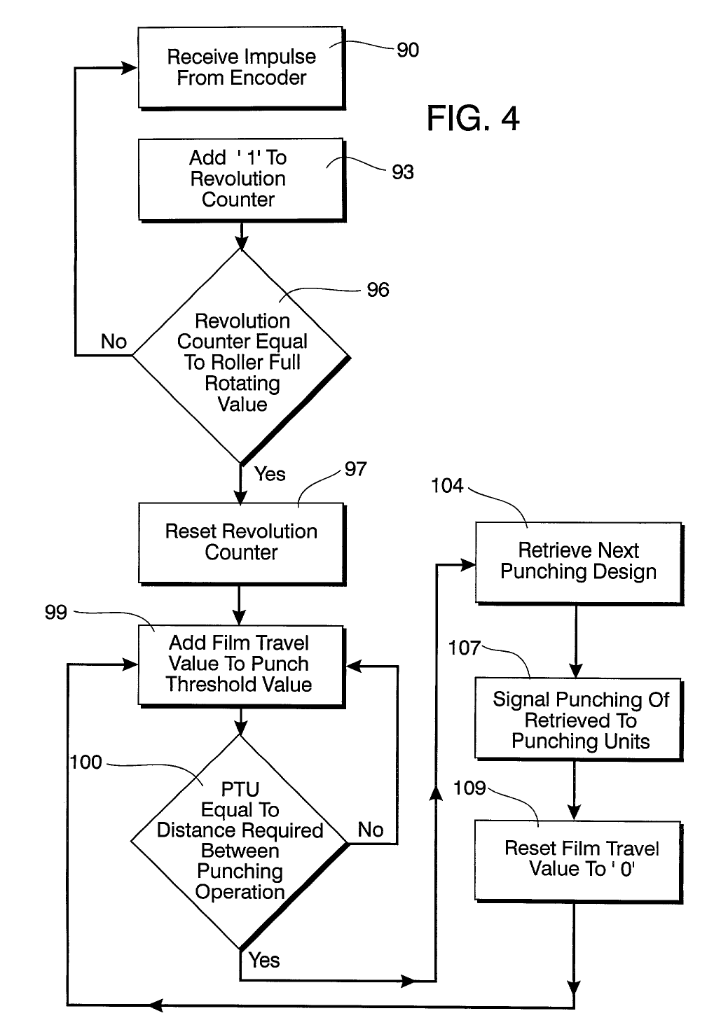

Die assembly 2 works in cooperation with plunger assembly 1 to punch holes in material 78 as follows: Plunger 59 containing steel ball 65 is powered downward as explained above. Steel ball 65 strikes the circular hole in die 70. The upper surface of the hole in die 70 which is fabricated from hardened tool steel, has a sharp edge. The sharp edge of the hole in die 70 cooperates with steel ball 65 to cut the material. It will be noted that the die assembly shown in FIG. 3 is positioned and held in place in the hole in frame member 5 as follows: Die 70 is contained in a nylon sleeve 71 which is machined to a shape that, working in cooperation with O-ring groove 75 in frame member 5, holds O-ring 73 in position to prevent the die assembly 2 from moving upward during operation of the machine. Retainer ring 72 is placed in a groove in die 70 so as to prevent the die 70 from moving upward out of sleeve 71 during operation. O-ring 73 farther functions to allow die assembly 2 to rotate freely in position and to have an amount of side to side movement sufficient to facilitate alignment of steel ball 65 with the hole in the upper surface of die 70 during the cutting process. Turning now to FIG. 4.

FIG. 4 illustrates an overview logic flow diagram of software process steps according to the invention's preferred embodiment. The computer readable and executed instruction set of the present invention can be embodied as either software, firmware of a combination thereof Such embodiment of said computer readable and executed instruction sets are well known and practiced by those skilled in the art.

The computer readable and executed instruction set of the present invention first receives an impulse from the encoder device mounted on a roller over which a film is passed 90. The software next adds 1 to a revolution counter 93 and then adds the value contained in the revolution counter to a rotor roller full rotation value 96. If the value in the revolution counter is not equal to the value in the full rotation counter value, the software returns to receive the next impulse to be received from the encoder 90. If the revolution counter is equal to the roller full rotation value 96, the software next resets the revolution counter to zero 97 and then adds a film traveled value to a punch threshold value in step 99. If the punch threshold value is equal to the distance required between subsequent punching operations 100, the software of the invention next retrieves the next punching design 104 and signals the punching of the retrieved design to the punching units located in the invention's apparatus 107. The film travel value is then reset to zero 109 and the software returns to calculate and add the next film travel value to the punch threshold value 99. Should, however, the punch press threshold value not be equaled to the distance required between punching operations 100, the software of the invention returns to wait for the next indication to add a film travel value to a punch threshold value at step 99.

From the foregoing description, it will be appreciated that numerous modifications may be made of this invention without departing from its spirit. Therefore, there is no intention to limit the scope of this invention to the specific embodiments illustrated and described. Rather, it is intended that the appended claims and their equivalents determine the scope of this invention.

Other objects and further scope of the applicability of the present invention will become apparent from the detailed description to follow, taken in conjunction with the accompanying drawings wherein like parts are designated by like reference numerals.

The foregoing description, for purposes of explanation, used specific nomenclature to provide a thorough understanding of the invention. However, it will be apparent to one skilled in the art that the specific details are not required in order to practice the invention. In other instances, well known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

Further, the method and system described herein above is amenable for execution on various types of executable mediums others than a memory device such as a random access memory. Other types of executable mediums can be used, such as but not limited to, a computer readable storage medium which can be any memory device, compact disc, or floppy disk.

While this invention has been described to illustrative embodiments, this description is not to be construed in a limiting sense. Various modifications and combinations of the illustrative embodiments as well as other embodiments will be apparent to those skilled in the art upon referencing this disclosure. It is therefore intended that this disclosure encompass any such modifications or embodiments.

What is claimed is:

1. A system for punching holes through a continuous film comprising:
a framework to facilitate transport of said continuous film;
an optical encoder mounted to a sensing roller; said sensing roller connected to a shaft and said framework and rotated via contact with said transported continuous film;
a plurality of transport rollers connected to shafts and said framework; said rollers rotated via contact with said transported continuous film;
software for signaling the punching of holes through said transported continuous film.

2. A method system for punching holes through a continuous film comprising:
determining a hole pattern to be punched through a continuously transported film;
determining a punching location for punching said determined hole pattern through said continuously transported film;
signaling the punching of said determined hole pattern through said continuously transported film at said determined punching location;
punching said determined hole pattern through said continuously transported film at said determined punching location.

3. The method of claim 2 wherein said determining a punching location for punching said determined hole pattern through said continuously transported film further comprises;
communication of a signal from an optical scanner to a computer; said signal indicating travel measures of said continuously transported film;
analyzing said communicated travel measures;
signaling the punching of a determined hole pattern whenever said analyzed travel measures reveal the presence of a punching location for punching said determined hole pattern through said continuously transported film.

4. The method of claim 2 wherein said signaling the punching of said determined hole pattern through said continuously transported film at said determined punch location further comprises the signaling and punching of a variable hole pattern through said continuously transported film at said determined punch location.

5. A computer program for punching holes through a transported continuous film comprising:
a code segment for determining an appropriate punching location for punching holes through said continuously transported film;
a code segment for signaling the punching of said holes through said continuously transported film at said appropriate punching location.

6. The computer program for punching holes through a transported continuous film according to claim 5 wherein said inputting a pre-selected hole pattern to be punched through said continuously transported film and further comprises the inputting and punching of a plurality of said pre-selected hole patterns.

7. The computer program for punching holes through a transported continuous film according to claim 5 wherein said determining an appropriate location for punching a hole pattern through said continuously transported film further comprises:
repeated punching of said pre-selected hole pattern for subsequent punching operations following first occasion of punching a hole pattern through said continuously transported film.

8. The computer program for punching holes through a transported continuous film according to claim 7 wherein said inputting a pre-selected hole pattern to be punched through said continuously transported film and further comprises the inputting and punching of a plurality of said pre-selected hole patterns.

9. An apparatus for punching holes through a transported continuous film comprising:
a framework,
a plurality of rollers attached to said framework;
an optical encoder attached to at least one roller within said plurality of rollers;
a punch assembly connected to said framework;
a solenoid valve connected to said punch assembly;
a compressed air source connected to said solenoid valve.

10. The apparatus of claim 9 further comprising:
a plurality of solenoid valves connected to a plurality of punch assemblies; said plurality of punch assemblies connected to said framework;
a computer communicably attached to said apparatus for punching holes through a transported continuous film.

11. A punched film produced according to the process of claim 2.

12. A punched film according to claim 11 wherein said film is essentially of polyethylene composition.

13. A punched film according to claim 11 wherein said film is essentially of non-polyethylene composition.

14. A punched film produced according to the process of claim 3.

15. A punched film produced according to the process of claim 4.
